(19) United States
(12) Patent Application Publication
(10) Pub. No.: US 2015/0299463 A1
(43) Pub. Date: Oct. 22, 2015

(54) FLAME-RETARDANT POLYCARBONATE MOLDING MATERIALS III

(71) Applicant: BAYER MATERIALSCIENCE AG, Leverkusen (DE)

(72) Inventors: Mathieu JUNG, Shanghai (CN); Thomas ECKEL, Dormagen (DE); Sven HOBEIKA, Solingen (DE)

(73) Assignee: BAYER MATERIALSCIENCE AG, Leverkusen (DE)

(21) Appl. No.: 14/649,234

(22) PCT Filed: Dec. 4, 2013
(86) PCT No.: PCT/EP2013/075490

§ 371 Date: Jun. 3, 2015

(30) Foreign Application Priority Data
Dec. 7, 2012 (EP) 12196019.9

(51) Int. Cl. C08L 69/00; C07F 9/659

(52) U.S. Cl. CPC C08L 69/005; C08L 69/00; C07F 9/659

(57) ABSTRACT

The present invention relates to flameproofed polycarbonate (PC) compositions and moulding compounds which have modified impact strength, good mechanical properties, good chemical resistance and high hydrolysis stability.

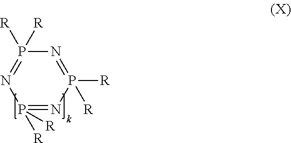

The present patent application further relates to the use of the compositions for the production of moulded articles and to the moulded articles produced from the compositions.

The present invention relates to flameproofed polycarbonate (PC) compositions comprising cyclic phosphazenes which have modified impact strength, high chemical resistance and high hydrolysis stability, to processes for their preparation and to the use of cyclic phosphazenes as flameproofing agents in polycarbonate compositions.

EP 1 095 099 A1 describes polycarbonate/ABS moulding compounds comprising phosphazenes and phosphorus compounds, which have excellent flame resistance and very good mechanical properties such as weld strength or notched impact strength.

EP 1 196 498 A1 describes moulding compounds comprising phosphazenes and based on polycarbonate and graft polymers selected from the group comprising silicone rubbers, EP(D)M rubbers and acrylate rubbers as the graft base, which have excellent flame resistance and very good mechanical properties such as stress cracking resistance or notched impact strength.

EP 1 095 100 A1 describes polycarbonate/ABS moulding compounds comprising phosphazenes and inorganic nanoparticles, which have excellent flame resistance and very good mechanical properties.

EP 1 095 097 A1 describes polycarbonate/ABS moulding compounds comprising phosphazenes, which have excellent flame resistance and very good processing properties, the graft polymer being prepared by bulk, solution or mass-suspension polymerization processes.

US2003/040643 A1 describes a process for the preparation of phenoxyphosphazene and polycarbonate/ABS moulding compounds comprising them. The moulding compounds have good flame resistance, good flowability, good impact strength and high dimensional stability under heat.

EP 0728811 A2 discloses polycarbonate/ABS moulding compounds comprising phosphazene as flameproofing agent. The moulding compounds have good flame resistance, high impact strength, high melt volume-flow rate and high flexural modulus.

JP 2000 351893 discloses impact-modified polycarbonate moulding compounds comprising phosphazenes which are distinguished by good hydrolysis stability, good flame resistance and stability of the electrical properties.

The documents cited above disclose linear and cyclic phosphazenes. In the case of cyclic phosphazenes, however, the proportions of trimers, tetramers and higher oligomers are not specified.

US2003/092802 A1 discloses phenoxyphosphazenes and their preparation and use in polycarbonate/ABS moulding compounds. The phenoxyphosphazenes are preferably crosslinked and the moulding compounds are distinguished by good flame resistance, good impact strength, high flexural modulus and high melt volume-flow rate. The ABS used is not described in greater detail. Furthermore, said document does not describe the proportions of trimers, tetramers and higher oligomers of the present patent application.

JP 2004 155802 discloses cyclic phosphazenes and their use in thermoplastic moulding compounds such as polycarbonate and ABS. Polycarbonate/ABS moulding compounds comprising cyclic phosphazenes with precisely defined proportions of trimers, tetramers and higher oligomers are not disclosed.

JP 1995 0038462 describes polycarbonate compositions comprising graft polymers, phosphazenes as flameproofing agents and optionally vinyl copolymers, although specific structures, compositions and amounts of the flameproofing agent are not mentioned.

JP 1999 0176718 describes thermoplastic compositions consisting of aromatic polycarbonate, copolymer of aromatic vinyl monomers and vinyl cyanides, graft polymer of alkyl (meth)acrylates and rubber, and phosphazene as flameproofing agent, which have a good flowability.

One object of the present invention is thus to provide a flameproofed moulding compound which is distinguished by a combination of properties consisting of high hydrolysis stability, high chemical resistance (ESC behaviour) and high E modulus, the mechanical properties remaining good.

Another object of the invention is to provide flameproofed moulding compounds which have good flame resistance with only a low phosphazene content, making these compositions more cost-effective since flameproofing agents are a substantial cost factor in the preparation of said compositions.

Preferably, the moulding compounds are flame-resistant and satisfy the UL 94 requirements with V-0, even at low wall thicknesses (i.e. wall thickness of 1.5 mm)

It was found, surprisingly, that compositions comprising:
A) 60-95 parts by weight, preferably 65-90 parts by weight, more preferably 70-85 parts by weight and particularly preferably 76-88 parts by weight of aromatic polycarbonate and/or aromatic polyestercarbonate,
B) 1.0-15.0 parts by weight, preferably 3.0-12.5 parts by weight and particularly preferably 4.0-10.0 parts by weight of rubber-modified graft polymer,
C) 1.0-14.5 parts by weight, preferably 1.5-9.0 parts by weight, more preferably 2.0-8.0 parts by weight and particularly preferably 4.5-8.0 parts by weight of at least one cyclic phosphazene of structure (X):

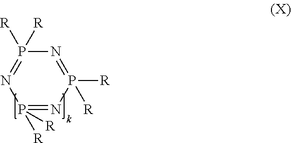

where
k is 1 or an integer from 1 to 10, preferably a number from 1 to 8 and particularly preferably 1 to 5,
   with a trimer content (k=1) of 60 to 98 mol %, more preferably of 65 to 95 mol %, particularly preferably of 65 to 90 mol % and very particularly preferably of 65-85 mol %, especially of 70-85 mol %, based on component C,
      and where
R are in each case identical or different and are an amine radical, C₁- to C₈-alkyl in each case optionally halogenated, preferably with fluorine, preferably methyl, ethyl, propyl or butyl, C₁- to C₈-alkoxy, preferably methoxy, ethoxy, propoxy or butoxy, C₅- to C₆-cycloalkyl in each case optionally substituted by alkyl, preferably C₁-C₄-alkyl, and/or halogen, preferably chlorine and/or bromine, C₆- to C₂₀-aryloxy in each case optionally substituted by alkyl, preferably C₁-C₄-alkyl, and/or halogen, preferably chlorine or bromine, and/or hydroxyl, preferably phenoxy or naphthyloxy, C₇- to C₁₂-aralkyl in each case optionally substituted by alkyl, preferably C₁-C₄-alkyl, and/or halogen, preferably chlorine and/or bromine, preferably phenyl-C₁-C₄-alkyl, or a halogen radical, preferably chlorine, or an OH radical,
D) 0-15.0 parts by weight, preferably 2.0-12.5 parts by weight, more preferably 3.0-9.0 parts by weight and particularly preferably 3.0-6.0 parts by weight of rubber-free vinyl (co)polymer or polyalkylene terephthalate,
E) 0-15.0 parts by weight, preferably 0.05-15.00 parts by weight, more preferably 0.2-10.0 parts by weight and particularly preferably 0.4-5.0 parts by weight of additives and
F) 0.05 to 5.00 parts by weight, preferably 0.1 to 2.0 parts by weight and particularly preferably 0.1 to 1.0 part by weight of antidripping agent,
   all the parts by weight in the present patent application preferably being scaled so that the sum of the parts by weight of all the components A+B+C+D+E+F in the composition is 100.

In one preferred embodiment the composition consists only of components A to F.

In one preferred embodiment the composition is free of inorganic flameproofing agents and flameproofing synergistic agents, especially aluminium hydroxide, aluminium oxide-hydroxide and arsenic and antimony oxides.

In one preferred embodiment the composition is free of other organic flameproofing agents, especially bisphenol A diphosphate oligomers, resorcinol diphosphate oligomers, triphenyl phosphate, octamethylresorcinol diphosphate and tetrabromo-bisphenol A diphosphate oligocarbonate.

The preferred embodiments can be carried out individually or in combination with one another.

The invention also provides processes for the preparation of the moulding compounds, the use of the moulding compounds for the production of moulded articles and the use of cyclic phosphazenes of defined oligomer distribution for the preparation of the compositions according to the invention.

The moulding compounds according to the invention can be used for the production of all kinds of moulded articles. These can be produced by injection moulding, extrusion and blow moulding processes. Another form of processing is the production of moulded articles by deep drawing from previously produced sheets or films.

Examples of such moulded articles are films; profiles; all kinds of housing parts, e.g. for domestic appliances such as juice presses, coffee machines and mixers, or for office machines such as monitors, flat screens, notebooks, printers and copiers; sheets; tubes; electrical conduits; windows, doors and other profiles for the building sector (interior and exterior applications); electrical and electronic parts such as switches, plugs and sockets; and body parts or interior trim for commercial vehicles, especially for the motor vehicle sector.

In particular, the moulding compounds according to the invention can also be used e.g. for the production of the following moulded articles or moulded parts: interior trim for rail vehicles, ships, aeroplanes, buses and other motor vehicles, housings for electrical equipment containing small transformers, housings for information processing and transmission equipment, housings and sheathing for medical equipment, housings for safety devices, moulded parts for sanitary and bath fittings, covering grids for ventilation apertures and housings for garden tools.

### Component A

Aromatic polycarbonates and/or aromatic polyestercarbonates that are suitable according to the invention as component A are known in the literature or can be prepared by processes known in the literature (for the preparation of aromatic polycarbonates see e.g. Schnell, “Chemistry and Physics of Polycarbonates”, Interscience Publishers, 1964, and DE-AS 1 495 626, DE-A 2 232 877, DE-A 2 703 376, DE-A 2 714 544, DE-A 3 000 610 and DE-A 3 832 396; for the preparation of aromatic polyestercarbonates see e.g. DE-A 3 007 934).

Aromatic polycarbonates are prepared e.g. by reacting diphenols with carbonic acid halides, preferably phosgene, and/or with aromatic dicarboxylic acid dihalides, preferably benzenedicarboxylic acid dihalides, by the phase interface process, optionally using chain terminators, e.g. monophenols, and optionally using trifunctional or more than trifunctional branching agents, e.g. triphenols or tetra-phenols. They can also be prepared by reacting diphenols with e.g. diphenyl carbonate by a melt polymerization process.

Diphenols for the preparation of the aromatic polycarbonates and/or aromatic polyestercarbonates are preferably those of formula (I):

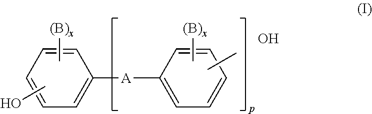

where
A is a single bond, C₁- to C₅-alkylene, C₂- to C₅-alkylidene, C₅- to C₆-cyclo-alkylidene, —O—, —SO—, —CO—, —S—, —SO₂—, C₆- to C₁₂-arylene to which further aromatic rings optionally containing heteroatoms can be fused, or a radical of formula (II) or (III):

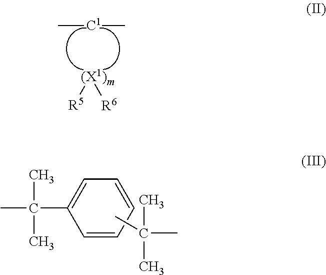

B are in each case C₁- to C₁₂-alkyl, preferably methyl, or halogen, preferably chlorine and/or bromine,
x independently of one another are in each case 0, 1 or 2,
p is 1 or 0 and
R⁵ and R⁶ can be individually chosen for each X¹ and independently of one another are hydrogen or C₁- to C₆-alkyl, preferably hydrogen, methyl or ethyl,
X¹ is carbon and
m is an integer from 4 to 7, preferably 4 or 5, with the proviso that R⁵ and R⁶ are simultaneously alkyl on at least one atom X¹.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes, and their ring-brominated and/or ring-chlorinated derivatives.

Particularly preferred diphenols are 4,4′-dihydroxydiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone and their di- and tetrabrominated or chlorinated derivatives, e.g. 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-Bis-(4-hydroxyphenyl)propane (bisphenol A) is particularly preferred.

The diphenols can be used individually or as any desired mixtures. The diphenols are known in the literature or obtainable by processes known in the literature.

Examples of suitable chain terminators for the preparation of the thermoplastic aromatic polycarbonates are phenol, p-chlorophenol, p-tert-butylphenol or 2,4,6-tribromophenol, as well as long-chain alkylphenols such as 4-[2-(2,4,4-trimethyl-pentyl)]phenol and 4-(1,3-tetramethylbutyl)phenol according to DE-A 2 842 005, or monoalkylphenols or dialkylphenols having a total of 8 to 20 carbon atoms in the alkyl substituents, such as 3,5-ditert-butylphenol, p-isooctylphenol, p-tert-octyl-phenol, p-dodecylphenol, 2-(3,5-dimethylheptyl)phenol and 4-(3,5-dimethylheptyl)-phenol. The amount of chain terminators to be used is generally between 0.5 mol % and 10 mol %, based on the molar sum of the particular diphenols used.

The thermoplastic aromatic polycarbonates have weight-average molecular weights (M_{w}, measured by GPC (gel permeation chromatography) with polycarbonate as standard) of 15,000 to 80,000 g/mol, preferably of 19,000 to 32,000 g/mol and particularly preferably of 22,000 to 30,000 g/mol.

The thermoplastic aromatic polycarbonates can be branched in known manner, preferably by the incorporation of 0.05 to 2.0 mol %, based on the sum of the diphenols used, of trifunctional or more than trifunctional compounds, e.g. those with three or more phenolic groups. The polycarbonates used are preferably linear and more preferably based on bisphenol A.

Both homopolycarbonates and copolycarbonates are suitable. Copolycarbonates according to the invention as component A can also be prepared using 1 to 25 wt %, preferably 2.5 to 25 wt % (based on the total amount of diphenols to be used), of polydiorganosiloxanes with hydroxyaryloxy end groups. These are known (U.S. Pat. No. 3,419,634) and can be prepared by processes known in the literature. Copolycarbonates comprising polydiorganosiloxanes are also suitable; the preparation of copolycarbonates comprising polydiorganosiloxanes is described e.g. in DE-A 3 334 782.

Aromatic dicarboxylic acid dihalides for the preparation of aromatic polyestercarbonates are preferably the diacid dichlorides of isophthalic acid, terephthalic acid, diphenyl ether 4,4′-dicarboxylic acid and naphthalene-2,6-dicarboxylic acid.

Mixtures of the diacid dichlorides of isophthalic acid and terephthalic acid in a ratio of between 1:20 and 20:1 are particularly preferred.

A carbonic acid halide, preferably phosgene, is additionally used concomitantly as a difunctional acid derivative in the preparation of polyestercarbonates.

Suitable chain terminators for the preparation of the aromatic polyestercarbonates, apart from the monophenols already mentioned, are their chlorocarbonic acid esters and the acid chlorides of aromatic monocarboxylic acids which can optionally be substituted by C₁- to C₂₂-alkyl groups or halogen atoms, as well as aliphatic C₂- to C₂₂-monocarboxylic acid chlorides.

The amount of chain terminators is 0.1 to 10 mol % in each case, based on moles of diphenol for phenolic chain terminators and on moles of dicarboxylic acid dichloride for monocarboxylic acid chloride chain terminators.

One or more aromatic hydroxycarboxylic acids can additionally be used in the preparation of aromatic polyestercarbonates.

The aromatic polyestercarbonates can be both linear and branched in known manner (cf. DE-A 2 940 024 and DE-A 3 007 934 in this connection), linear polyestercarbonates being preferred.

Examples of branching agents which can be used are trifunctional or more than trifunctional carboxylic acid chlorides such as trimesic acid trichloride, cyanuric acid trichloride, benzophenone-3,3′,4,4′-tetracarboxylic acid tetrachloride, naphthalene-1,4,5,8-tetracarboxylic acid tetrachloride or pyromellitic acid tetrachloride, in amounts of 0.01 to 1.0 mol % (based on the dicarboxylic acid dichlorides used), or trifunctional or more than trifunctional phenols such as phloroglucinol, 4,6-dimethyl-2,4,6-tri(4-hydroxyphenyl)-2-heptene, 4,6-dimethyl-2,4,6-tri(4-hydroxyphenyl)heptane, 1,3,5-tri(4-hydroxyphenyl)benzene, 1,1,1-tri(4-hydroxyphenyl)-ethane, tri(4-hydroxyphenyl)phenylmethane, 2,2-bis[4,4-bis(4-hydroxyphenyl)-cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]-phenoxy)methane or 1,4-bis[4,4′-(dihydroxytriphenyl)methyl]benzene, in amounts of 0.01 to 1.0 mol %, based on the diphenols used. Phenolic branching agents can be used with the diphenols; acid chloride branching agents can be introduced together with the acid dichlorides.

The proportion of carbonate structural units in the thermoplastic aromatic polyestercarbonates can vary freely. The proportion of carbonate groups is preferably up to 100 mol %, especially up to 80 mol % and particularly preferably up to 50 mol %, based on the sum of the ester groups and carbonate groups. Both the ester part and the carbonate part of the aromatic polyestercarbonates can be present in the polycondensation product in the form of blocks or as a random distribution.

The thermoplastic aromatic polycarbonates and polyestercarbonates can be used on their own or in any desired mixture.

### Component B

The graft polymers B include e.g. those with rubber-elastic properties essentially obtainable from at least 2 of the following monomers: chloroprene, 1,3-butadiene, isoprene, styrene, acrylonitrile, ethylene, propylene, vinyl acetate and (meth)acrylic acid esters having 1 to 18 C atoms in the alcohol component, i.e. polymers such as those described e.g. in “Methoden der Organischen Chemie” (Houben-Weyl), vol. 14/1, Georg Thieme-Verlag, Stuttgart 1961, pp 393-406, and C. B. Bucknall, “Toughened Plastics”, Appl. Science Publishers, London 1977.

Examples of particularly preferred polymers B are ABS polymers (emulsion, bulk and suspension ABS) such as those described e.g. in DE-OS 2 035 390 (=U.S. Pat. No. 3,644,574), DE-OS 2 248 242 (=GB-PS 1 409 275) or Ullmanns Enzyklopadie der Technischen Chemie, vol. 19 (1980), p. 280 et seq.

The graft copolymers B are prepared by free-radical polymerization, e.g. by emulsion, suspension, solution or bulk polymerization, preferably emulsion or bulk polymerization.

Preferred polymers B are partially crosslinked and have gel contents (measured in toluene) of over 20 wt %, preferably of over 40 wt % and especially of over 60 wt %.

The gel content is determined at 25° C. in a suitable solvent (M. Hoffmann, H. Krömer, R. Kuhn, Polymeranalytik I and II, Georg Thieme-Verlag, Stuttgart 1977).

Preferred graft polymers B include those consisting of:
B.1) 5 to 95 parts by weight, preferably 30 to 80 parts by weight, of a mixture of
B.1.1) 50 to 95 parts by weight of styrene, a-methylstyrene, styrene ring-substituted by methyl, C₁-C₈-alkyl methacrylate, especially methyl methacrylate, C₁-C₈-alkyl acrylate, especially methyl acrylate, or mixtures of these compounds, and
B.1.2) 5 to 50 parts by weight of acrylonitrile, methacrylonitrile, C₁-C₈-alkyl methacrylates, especially methyl methacrylate, C₁-C₈-alkyl acrylate, especially methyl acrylate, maleic anhydride, maleimides N-substituted by C₁-C₄-alkyl or phenyl, or mixtures of these compounds,
on
B.2) 5 to 95 parts by weight, preferably 20 to 70 parts by weight, of a rubber-containing graft base.

The glass transition temperature of the graft base is preferably below −10° C.

Unless indicated otherwise in the present invention, glass transition temperatures are determined by differential scanning calorimetry (DSC) according to standard DIN EN 61006 at a heating rate of 10 K/min with Tg defined as the mid-point temperature (tangent method) and nitrogen as the inert gas.

A particularly preferred graft base is one based on a polybutadiene rubber.

Examples of preferred graft polymers B are polybutadienes, butadiene/styrene copolymers and acrylate rubbers grafted with styrene and/or acrylonitrile and/or (meth)acrylic acid alkyl esters, i.e. copolymers of the type described in DE-OS 1 694 173 (=U.S. Pat. No. 3,564,077); and polybutadienes, butadiene/styrene or butadiene/acrylonitrile copolymers, polyisobutenes or polyisoprenes grafted with acrylic or methacrylic acid alkyl esters, vinyl acetate, acrylonitrile, styrene and/or alkyl-styrenes, such as those described e.g. in DE-OS 2 348 377 (=U.S. Pat. No. 3,919,353).

Particularly preferred graft polymers B are those obtainable by the grafting reaction of:
I. 10 to 70 wt %, preferably 15 to 50 wt % and especially 20 to 40 wt %, based on the graft product, of at least one (meth)acrylic acid ester, or 10 to 70 wt %, preferably 15 to 50 wt % and especially 20 to 40 wt % of a mixture of 10 to 50 wt %, preferably 20 to 35 wt %, based on the mixture, of acrylonitrile or (meth)acrylic acid ester and 50 to 90 wt %, preferably 65 to 80 wt %, based on the mixture, of styrene,
   on to
II. 30 to 90 wt %, preferably 40 to 85 wt % and especially 50 to 80 wt %, based on the graft product, of a butadiene polymer comprising at least 50 wt %, based on II, of butadiene radicals as the graft base.

It is very particularly preferable according to the invention to use ABS (acrylonitrile/butadiene/styrene) as the graft polymer.

The gel content of this graft base II is preferably at least 70 wt % (measured in toluene), the degree of grafting G is 0.15 to 0.55 and the mean particle diameter d₅₀ of the graft polymer B is 0.05 to 2 μm, preferably 0.1 to 0.6 μm.

(Meth)acrylic acid esters I are esters of acrylic acid or methacrylic acid and monohydric alcohols having 1 to 18 C atoms. Methyl, ethyl and propyl methacrylate are particularly preferred.

Apart from butadiene radicals, the graft base II can comprise up to 50 wt %, based on II, of radicals of other ethylenically unsaturated monomers such as styrene, acrylonitrile, acrylic or methacrylic acid esters having 1 to 4 C atoms in the alcohol component (such as methyl acrylate, ethyl acrylate, methyl methacrylate, ethyl methacrylate), vinyl esters and/or vinyl ethers. The preferred graft base II consists of pure polybutadiene.

As it is known that, in the grafting reaction, the graft monomers are not necessarily completely grafted on to the graft base, graft polymers B are also understood according to the invention as meaning products that are obtained by polymerization of the graft monomers in the presence of the graft base.

The degree of grafting G denotes the weight ratio of grafted-on graft monomers to graft base and is dimensionless.

The mean particle size d₅₀ is the diameter above which 50 wt % of the particles fall and below which 50 wt % of the particles fall. It can be determined by ultra-centrifuge measurements (W. Scholtan, H. Lange, Kolloid-Z. and Z. für Polymere 250 (1972), 782-796).

Examples of other preferred graft polymers B are those consisting of:
(a) 20 to 90 wt %, based on B, of acrylate rubber as graft base, and
(b) 10 to 80 wt %, based on B, of at least one polymerizable, ethylenically unsaturated monomer whose homopolymers or copolymers formed in the absence of (a) would have a glass transition temperature above 25° C., as graft monomers.

The graft base of acrylate rubber preferably has a glass transition temperature below −20° C., preferably below −30° C.

The acrylate rubbers (a) of the polymers B are preferably polymers of acrylic acid alkyl esters, optionally with up to 40 wt %, based on (a), of other polymerizable, ethylenically unsaturated monomers. The preferred polymerizable acrylic acid esters include C₁-C₈-alkyl esters, e.g. methyl, ethyl, n-butyl, n-octyl and 2-ethylhexyl esters, and mixtures of these monomers.

For crosslinking, monomers with more than one polymerizable double bond can be copolymerized. Preferred examples of crosslinking monomers are esters of unsaturated monocarboxylic acids having 3 to 8 C atoms and unsaturated monohydric alcohols having 3 to 12 C atoms or saturated polyols having 2 to 4 OH groups and 2 to 20 C atoms, e.g. ethylene glycol dimethacrylate, allyl methacrylate, poly-unsaturated heterocyclic compounds such as trivinyl and triallyl cyanurate, poly-functional vinyl compounds such as di- and trivinylbenzenes, and also triallyl phosphate and diallyl phthalate.

Preferred crosslinking monomers are allyl methacrylate, ethylene glycol dimethacrylate, diallyl phthalate, and heterocyclic compounds having at least 3 ethylenically unsaturated groups.

Particularly preferred crosslinking monomers are the cyclic monomers triallyl cyanurate, triallyl isocyanurate, trivinyl cyanurate, triacryloylhexahydro-s-triazine and triallylbenzenes.

The amount of crosslinking monomers is preferably 0.02 to 5 wt %, especially 0.05 to 2 wt %, based on the graft base (a).

In the case of cyclic crosslinking monomers having at least 3 ethylenically unsaturated groups, it is advantageous to restrict the amount to less than 1 wt % of the graft base (a).

Examples of ‘other’ preferred polymerizable, ethylenically unsaturated monomers which, apart from the acrylic acid esters, can optionally be used to prepare the graft base (a) are acrylonitrile, styrene, a-methylstyrene, acrylamides, vinyl C₁-C₆-alkyl ethers, methyl methacrylate and butadiene. Preferred acrylate rubbers as the graft base (a) are emulsion polymers having a gel content of at least 60 wt %.

### Component C

Phosphazenes of component C which are used according to the present invention are cyclic phosphazenes of formula (X):

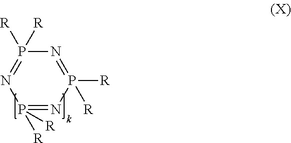

where
R are in each case identical or different and are
   an amine radical,
   C₁- to C₈-alkyl in each case optionally halogenated, preferably with fluorine and more preferably monohalogenated, preferably methyl, ethyl, propyl or butyl,
   C₁- to C₈-alkoxy, preferably methoxy, ethoxy, propoxy or butoxy,
   C₅- to C₆-cycloalkyl in each case optionally substituted by alkyl, preferably C₁-C₄-alkyl, and/or halogen, preferably chlorine and/or bromine,
   C₆- to C₂₀-aryloxy in each case optionally substituted by alkyl, preferably C₁-C₄-alkyl, and/or halogen, preferably chlorine or bromine, and/or hydroxyl, preferably phenoxy or naphthyloxy,
   C₇- to C₁₂-aralkyl in each case optionally substituted by alkyl, preferably C₁-C₄-alkyl, and/or halogen, preferably chlorine and/or bromine, preferably phenyl-C₁-C₄-alkyl, or
   a halogen radical, preferably chlorine or fluorine, or
   an OH radical, and
k is as defined above.

The following are preferred:

propoxyphosphazene, phenoxyphosphazene, methylphenoxyphosphazene, amino-phosphazene and fluoroalkylphosphazenes, as well as phosphazenes of the following structures:

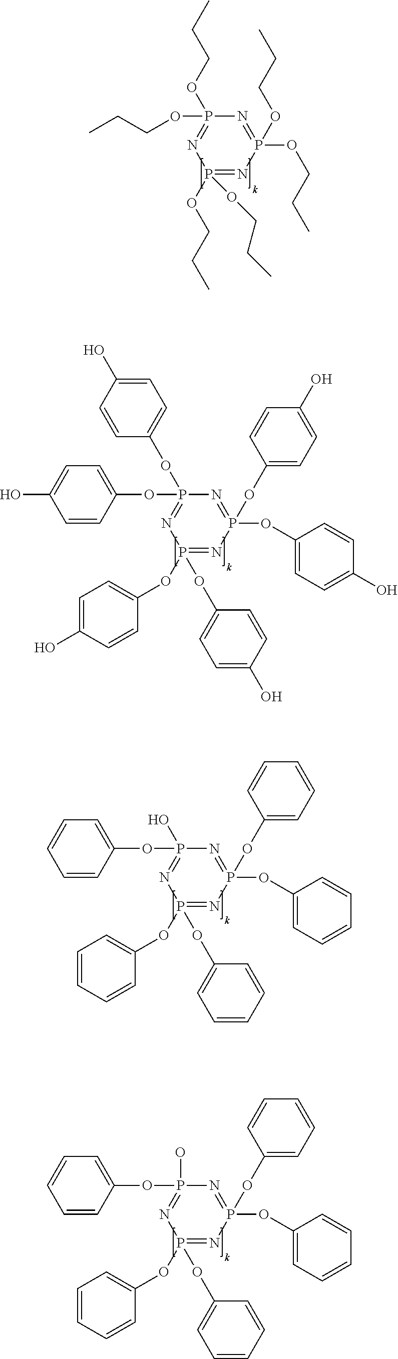

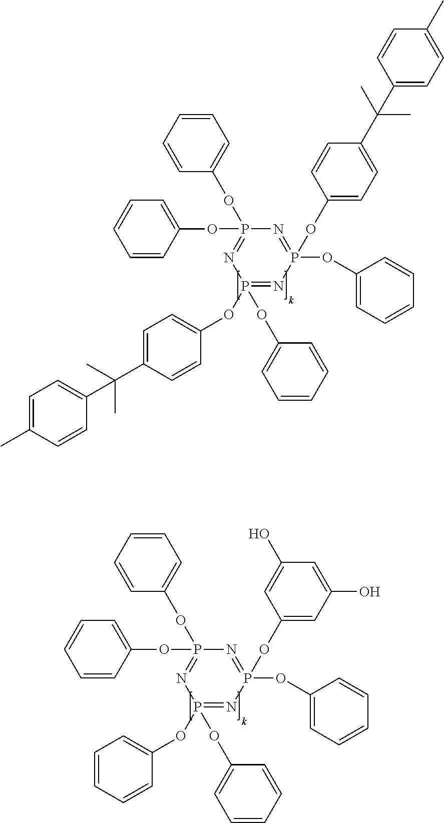

In the compounds shown above, k=1, 2 or 3.

The preferred compound is phenoxyphosphazene (all R=phenoxy) with an oligomer content where k=1 (C1) of 60 to 98 mol %.

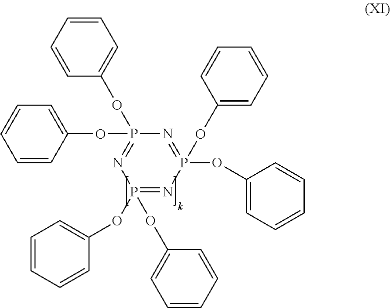

In the case where the phosphazene of formula (X) is halogen-substituted on the phosphorus, e.g. from incompletely reacted starting material, the proportion of this phosphazene halogen-substituted on the phosphorus is preferably less than 1000 ppm, more preferably less than 500 ppm.

The phosphazenes can be used on their own or as a mixture, i.e. the radicals R can be identical or 2 or more radicals in formula (X) can be different. Preferably, the radicals R of a phosphazene are identical.

In a more preferred embodiment, only phosphazenes with identical R are used.

In one preferred embodiment the tetramer content (k=2) (C2), based on component C, is from 2 to 50 mol %, more preferably from 5 to 40 mol %, even more preferably from 10 to 30 mol % and particularly preferably from 10 to 20 mol %.

In one preferred embodiment the higher oligomeric phosphazene content (k=3, 4, 5, 6 and 7) (C3), based on component C, is from 0 to 30 mol %, more preferably from 2.5 to 25 mol %, even more preferably from 5 to 20 mol % and particularly preferably from 6 to 15 mol %.

In one preferred embodiment the oligomer content where k≧8 (C4), based on component C, is from 0 to 2.0 mol %, preferably from 0.10 to 1.00 mol %.

In a more preferred embodiment the phosphazenes of component C satisfy all three of the aforementioned conditions in respect of contents (C2-C4).

Preferably, component C is a phenoxyphosphazene with a trimer content (k=1) of 65 to 85 mol %, a tetramer content (k=2) of 10 to 20 mol %, a higher oligomeric phosphazene content (k=3, 4, 5, 6 and 7) of 5 to 20 mol % and a phosphazene oligomer content where k≧8 of 0 to 2 mol %, based on component C.

Particularly preferably, component C is a phenoxyphosphazene with a trimer content (k=1) of 70 to 85 mol %, a tetramer content (k=2) of 10 to 20 mol %, a higher oligomeric phosphazene content (k=3, 4, 5, 6 and 7) of 6 to 15 mol % and a phosphazene oligomer content where k≧8 of 0.1 to 1 mol %, based on component C.

In another particularly preferred embodiment, component C is a phenoxyphosphazene with a trimer content (k=1) of 65 to 85 mol %, a tetramer content (k=2) of 10 to 20 mol %, a higher oligomeric phosphazene content (k=3, 4, 5, 6 and 7) of 5 to 15 mol % and a phosphazene oligomer content where k≧8 of 0 to 1 mol %, based on component C.

The weighted arithmetic mean of k is defined by n according to the following formula:

$$n = \frac{{\sum }_{i = 1}^{max} {k}_{i} \cdot {x}_{i}}{{\sum }_{i = 1}^{max} {x}_{i}}$$

where xᵢ is the content of oligomer so the sum of all xᵢ is equal to 1.

In one alternative embodiment n is in the range from 1.10 to 1,75, preferably from 1.15 to 1.50, more preferably from 1.20 to 1.45 and particularly preferably from 1.20 to 1.40 (inclusive of limits).

The phosphazenes and their preparation are described e.g. in EP-A 728 811, DE-A 1 961 668 and WO 97/40092.

The oligomer compositions of the phosphazenes in the respective blend samples can also be detected and quantified, after compounding, by ³¹P-NMR (chemical shift; δ trimer: 6.5 to 10.0 ppm; δ tetramer: −10 to −13.5 ppm; δ higher oligomers: −16.5 to −25.0 ppm).

### Component D

Component D comprises one or more thermoplastic vinyl (co)polymers or polyalkylene terephthalates.

Suitable vinyl (co)polymers D are polymers of at least one monomer from the group comprising vinylaromatics, vinyl cyanides (unsaturated nitriles), (meth)acrylic acid C₁-C₈-alkyl esters, unsaturated carboxylic acids and derivatives (such as anhydrides and imides) of unsaturated carboxylic acids. Particularly suitable (co)polymers are those consisting of:
D.1 50 to 99 parts by weight, preferably 60 to 80 parts by weight, of vinylaromatics and/or ring-substituted vinylaromatics (such as styrene, α-methylstyrene, p-methylstyrene, p-chlorostyrene) and/or (meth)acrylic acid C₁-C₈-alkyl esters (such as methyl methacrylate, ethyl methacrylate), and
D.2 1 to 50 parts by weight, preferably 20 to 40 parts by weight, of vinyl cyanides (unsaturated nitriles) (such as acrylonitrile and methacrylonitrile) and/or (meth)acrylic acid C₁-C₈-alkyl esters (such as methyl methacrylate, n-butyl acrylate, t-butyl acrylate) and/or unsaturated carboxylic acids (such as maleic acid) and/or derivatives (such as anhydrides and imides) of unsaturated carboxylic acids (e.g. maleic anhydride and N-phenylmaleimide).

The vinyl (co)polymers D are resinous, thermoplastic and rubber-free. The copolymer of styrene as D.1 and acrylonitrile as D.2 is particularly preferred.

The (co)polymers D are known and can be prepared by free-radical polymerization, especially by emulsion, suspension, solution or bulk polymerization. The (co)-polymers preferably have weight-average molecular weights M_{w} (determined by light scattering or sedimentation) of between 15,000 and 200,000 g/mol, particularly preferably of between 100,000 and 150,000 g/mol.

In one particularly preferred embodiment D is a copolymer of 77 wt % of styrene and 23 wt % of acrylonitrile with a weight-average molecular weight M_{w} of 130,000 g/mol.

According to the invention, the compositions comprise one polyalkylene terephthalate or a mixture of two or more different polyalkylene terephthalates suitable as component D.

In terms of the invention, polyalkylene terephthalates are those derived from terephthalic acid (or its reactive derivatives, e.g. dimethyl esters or anhydrides) and alkanediols, cycloaliphatic or araliphatic diols and mixtures thereof, e.g. based on propylene glycol, butanediol, pentanediol, hexanediol, 1,2-cyclohexanediol, 1,4-cyclohexanediol, 1,3-cyclohexanediol and cyclohexyldimethanol, the diol component according to the invention having more than 2 carbon atoms. Accordingly, it is preferable to use polybutylene terephthalate and/or poly-trimethylene terephthalate and most preferable to use polybutylene terephthalate as component D.

The polyalkylene terephthalates according to the invention can also comprise up to 5 wt % of isophthalic acid as a monomer of the diacid.

Preferred polyalkylene terephthalates can be prepared by known methods (Kunststoff-Handbuch, vol. VIII, p. 695 et seq., Carl-Hanser-Verlag, Munich 1973) from terephthalic acid (or its reactive derivatives) and aliphatic or cycloaliphatic diols having 3 to 21 C atoms.

Preferred polyalkylene terephthalates comprise at least 80 mol %, preferably at least 90 mol %, based on the diol component, of 1,3-propanediol and/or 1,4-butanediol radicals.

Apart from terephthalic acid radicals, the preferred polyalkylene terephthalates can comprise up to 20 mol % of radicals of other aromatic dicarboxylic acids having 8 to 14 C atoms or of aliphatic dicarboxylic acids having 4 to 12 C atoms, such as radicals of phthalic acid, isophthalic acid, naphthalene-2,6-dicarboxylic acid, biphenyl-4,4′-dicarboxylic acid, succinic acid, adipic acid, sebacic acid, azelaic acid, cyclohexanediacetic acid and cyclohexanedicarboxylic acid.

Apart from 1,3-propanediol or 1,4-butanediol radicals, the preferred polyalkylene terephthalates can comprise up to 20 mol % of other aliphatic diols having 3 to 12 C atoms or of cycloaliphatic diols having 6 to 21 C atoms, e.g. radicals of 2-ethyl-1,3-propanediol, neopentyl glycol, 1,5-pentanediol, 1,6-hexanediol, cyclohexane-1,4-dimethanol, 3-methyl-2,4-pentanediol, 2-methyl-2,4-pentanediol, 2,2,4-trimethyl-1,3-pentanediol, 2-ethyl-1,6-hexanediol, 2,2-diethyl-1,3-propanediol, 2,5-hexanediol, 1,4-di((3-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)-propane and 2,2-bis(4-hydroxypropoxyphenyl)propane (DE-A 24 07 674, 24 07 776, 27 15 932).

The polyalkylene terephthalates can be branched by the incorporation of relatively small amounts of tri- or tetrahydric alcohols or tri- or tetrabasic carboxylic acids, such as those described e.g. in DE-A 19 00 270 and U.S. Pat. No. 3,692,744. Examples of preferred branching agents are trimesic acid, trimellitic acid, trimethylolethane, trimethylolpropane and pentaerythritol.

It is advisable to use no more than 1 mol % of branching agent, based on the acid component.

Particularly preferred polyalkylene terephthalates are those which have been prepared only from terephthalic acid or its reactive derivatives (e.g. its dialkyl esters such as dimethyl terephthalate) and 1,3-propanediol and/or 1,4-butanediol (polypropylene terephthalate and polybutylene terephthalate) and mixtures of these polyalkylene terephthalates.

Other preferred polyalkylene terephthalates are copolyesters prepared from at least two of the aforementioned acid components and/or from at least two of the aforementioned alcohol components, particularly preferred copolyesters being poly(1,3-propylene glycol/1,4-butanediol) terephthalates.

The polyalkylene terephthalates generally have an intrinsic viscosity of approx. 0.4 to 1.5 dl/g, preferably of 0.5 to 1.3 dl/g, measured in each case in phenol/o-dichlorobenzene (1:1 parts by weight) at 25° C.

In one alternative embodiment the polyesters prepared according to the invention can also be used in a mixture with other polyesters and/or other polymers, preference being afforded to mixtures of polyalkylene terephthalates with other polyesters.

### Other Additives E

The composition can comprise other conventional polymer additives such as flameproofing synergistic agents apart from antidripping agent, lubricants and demoulding agents (e.g. pentaerythritol tetrastearate), nucleating agents, stabilizers (e.g. UV/light stabilizers, heat stabilizers, antioxidants, transesterification inhibitors, hydrolysis stabilizers), antistatic agents (e.g. conductive carbon blacks, carbon fibres, carbon nanotubes and organic antistatic agents such as polyalkylene ethers, alkylsulfonates or polyamide-containing polymers), dyestuffs, pigments, fillers and reinforcing agents, especially glass fibres, mineral reinforcing agents and carbon fibres.

As stabilizers it is preferable to use sterically hindered phenols and phosphites or mixtures thereof, e.g. Irganox® B900 (Ciba Speciality Chemicals). As a demoulding agent it is preferable to use pentaerythritol tetrastearate. It is also preferable to add carbon black as a black pigment (e.g. black pearls).

Apart from other optional additives, particularly preferred moulding compounds comprise as component E 0.1 to 1.5 parts by weight, preferably 0.2 to 1.0 part by weight and particularly preferably 0.3 to 0.8 part by weight of a demoulding agent, particularly preferably pentaerythritol tetrastearate.

Apart from other optional additives, particularly preferred moulding compounds comprise as component E 0.01 to 0.5 part by weight, preferably 0.03 to 0.4 part by weight and particularly preferably 0.06 to 0.3 part by weight of at least one stabilizer selected e.g. from the group comprising sterically hindered phenols, phosphites and mixtures thereof, particularly preferably Irganox® B900.

A combination of PTFE (component F), pentaerythritol tetrastearate and Irganox B900 with a phosphorus-based flameproofing agent, as component C, is also particularly preferred.

### Component F

Polytetrafluoroethylene (PTFE) or PTFE-containing compositions, e.g. master-batches of PTFE with polymers or copolymers comprising styrene or methyl methacrylate, are used in particular as antidripping agents, either as a powder or as a coagulated mixture, e.g. with component B.

The fluorinated polyolefins used as antidripping agents are high-molecular and have glass transition temperatures above −30° C., usually above 100° C., fluorine contents preferably of 65 to 76 wt %, especially of 70 to 76 wt %, and mean particle diameters d₅₀ of 0.05 to 1000 μm, preferably of 0.08 to 20 μm. In general the fluorinated polyolefins have a density of 1.2 to 2.3 g/cm³. Preferred fluorinated polyolefins are polytetrafluoroethylene, polyvinylidene fluoride, tetrafluoroethylene/hexafluoro-propylene copolymers and ethylene/tetrafluoroethylene copolymers. The fluorinated polyolefins are known (cf. “Vinyl and Related Polymers” by Schildknecht, John Wiley & Sons, Inc., New York, 1962, pages 484-494; “Fluoropolymers” by Wall, Wiley-Interscience, John Wiley & Sons, Inc., New York, volume 13, 1970, pages 623-654; “Modern Plastics Encyclopedia”, 1970-1971, volume 47, No. 10 A, October 1970, McGraw-Hill, Inc., New York, pages 134 and 774; “Modem Plastics Encyclopedia”, 1975-1976, October 1975, volume 52, No. 10 A, McGraw-Hill, Inc., New York, pages 27, 28 and 472; and U.S. Pat. Nos. 3,671,487, 3,723,373 and 3,838,092).

They can be prepared by known processes, e.g. by the polymerization of tetrafluoroethylene in an aqueous medium with a catalyst that forms free radicals, e.g. sodium, potassium or ammonium peroxydisulfate, at pressures of 7 to 71 kg/cm² and at temperatures of 0 to 200° C., preferably at temperatures of 20 to 100° C. (See e.g. U.S. Pat. No. 2,393,967 for further details.) Depending on the form in which they are used, the density of these materials can be between 1.2 and 2.3 g/cm³ and the mean particle size between 0.05 and 1000 μm.

The fluorinated polyolefins which are preferred according to the invention have mean particle diameters of 0.05 to 20 μm, preferably of 0.08 to 10 μm, and a density of 1.2 to 1.9 g/cm³.

Suitable fluorinated polyolefins F which can be used in powder form are tetrafluoroethylene polymers with mean particle diameters of 100 to 1000 μm and densities of 2.0 g/cm³ to 2.3 g/cm³. Suitable powders of tetrafluoroethylene polymers are commercially available products and are sold e.g. by DuPont under the trade name Teflon®.

Apart from other optional additives, particularly preferred flameproofed compositions comprise as component F 0.05 to 5.0 parts by weight, preferably 0.1 to 2.0 parts by weight and particularly preferably 0.3 to 1.0 part by weight of a fluorinated polyolefin.

The Examples which follow serve to illustrate the invention in greater detail.

### Component A

Linear polycarbonate based on bisphenol A with a weight-average molecular weight M̅w of 27,500 g/mol (determined by GPC in dichloromethane with polycarbonate as standard).

### Component B

ABS graft polymer prepared by the emulsion polymerization of 43 wt %, based on the ABS polymer, of a mixture of 27 wt % of acrylonitrile and 73 wt % of styrene, in the presence of 57 wt %, based on the ABS polymer, of a particulate crosslinked polybutadiene rubber (mean particle size d₅₀=0.35 μm).

### Component C

Phenoxyphosphazene of formula (XI) with an oligomer content where k=1 of 40 to 100 mol %, an oligomer content where k=2 of 0 to 35 mol % and an oligomer content where k≧3 of 0 to 35 mol %, as shown in Table 1.

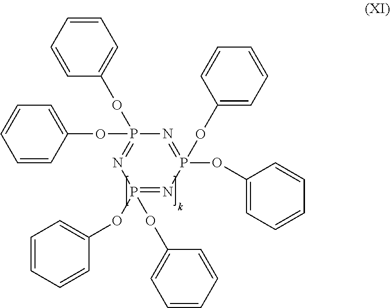

| | Ex. 1 | Ex. 2 | Ex. 3 | Ex. 4 | Ex. 5 | Ex. 6 |
|---|---|---|---|---|---|---|
| Example | C1 | C2 | C3 | C4 | C5 | C6 |
| Content where k = 1 | 40.5 | 64.5 | 71.6 | 82.2 | 90.8 | 100.0 |
| (mol %) | | | | | | |
| Content where k = 2 | 30.8 | 21.3 | 18.6 | 11.1 | 6.1 | 0 |
| (mol %) | | | | | | |
| Content where k ≧ 3 | 28.6 | 14.1 | 9.8 | 6.7 | 3.2 | 0 |
| (mol %) | | | | | | |

### Component D

Copolymer of 77 wt % of styrene and 23 wt % of acrylonitrile with a weight-average molecular weight M_{w} of 130 kg/mol (determined by GPC), prepared by the bulk process.

### Component E1

Pentaerythritol tetrastearate as lubricant/demoulding agent.

### Component E2

Heat stabilizer Irganox® B900 (mixture of 80% of Irgafos® 168 (tris(2,4-ditert-butylphenyl) phosphite) and 20% of Irganox® 1076 (2,6-ditert-butyl-4-(octa-decanoxycarbonylethyl)phenol); BASF AG; Ludwigshafen).

### Component F

Polytetrafluoroethylene powder, CFP 6000 N, Du Pont.

### Preparation and Testing of the Moulding Compounds

The starting materials listed in Table 2 are compounded and granulated on a twin-screw extruder (ZSK-25) (Werner and Pfleiderer) at a speed of rotation of 225 rpm, a throughput of 20 kg/h and a machine temperature of 260° C.

The finished granules are processed to the appropriate test pieces on an injection moulding machine (melt temperature 240° C., mould temperature 80° C., flow-front speed 240 mm/s)

The following methods were used to characterize the properties of the materials:

The IZOD notched impact strength was measured according to ISO 180/1A on 80 mm×10 mm×4 mm side-gated test bars.

The weld strength anF was measured according to ISO 179/1eU on an 80×10×4 mm end-gated test bar.

The combustion behaviour is measured according to UL 94 V on 127×12.7×1.5 mm bars.

The tensile modulus and elongation at break were determined according to ISO 527 on 170 mm×10 mm×4 mm tensile dumb-bells.

The dimensional stability under heat was measured according to ISO 306 (Vicat softening point, method B with a load of 50 N and a heating rate of 120 K/h) on 80 mm×10 mm×4 mm side-gated test bars.

The stress cracking behaviour (ESC behaviour) was tested on 80×10×4 mm bars at a processing temperature of 240° C. using rapeseed oil as the test medium. The test pieces were prestretched by means of a circular template (prestretching in percent) and stored in the test medium at room temperature. The stress cracking behaviour was evaluated as the time taken for cracking or fracture to occur in the test medium.

The melt flowability was assessed by means of the melt volume-flow rate (MVR), measured according to ISO 1133 at a temperature of 240° C. and with a plunger load of 5 kg.

The hydrolysis stability of the compositions prepared was measured as the change in MVR, measured according to ISO 1133 at 240° C. and with a plunger load of 5 kg, after storage of the granules for 7 days at 95° C. and 100% relative humidity (“FWL storage”). The increase in the MVR value compared with the MVR value before said storage was calculated as ΔMVR(hydr.), which is defined by the following formula:

$$Δ MVR ( hydr . ) = \frac{MVR ( after FWL storage ) - MVR ( before storage )}{MVR ( before storage )} \cdot 100 \%$$

Table 2 shows that the compositions of Examples 2, 3, 4 and 5, in which the phosphazene content where k=1 (trimer) is between 50 mol %≦x≦98 mol %, based on component C, achieve the object of the invention, i.e. exhibit a combination of good hydrolysis stability (≦65% deviation from the initial value of the MVR 240° C./5 kg after storage for 7 d/95° C./100% rel. humidity), chemical resistance (cracking and/or fracture of the test bars after ≧6 hours), temperature stability and E modulus, coupled with a UL 94 V-0 classification at 1.5 mm

TABLE 2
Composition and properties of the moulding compounds

| | Ex. 1 (Comp.) | Ex. 2 | Ex. 3 | Ex. 4 | Ex. 5 | Ex. 6 (Comp.) |
|---|---|---|---|---|---|---|
| Components (parts by weight) | | | | | | |
| A | 81.6 | 81.6 | 81.6 | 81.6 | 81.6 | 81.6 |
| B | 5.0 | 5.0 | 5.0 | 5.0 | 5.0 | 5.0 |
| C1 | 7.5 | | | | | |
| C2 | | 7.5 | | | | |
| C3 | | | 7.5 | | | |
| C4 | | | | 7.5 | | |
| C5 | | | | | 7.5 | |
| C6 | | | | | | 7.5 |
| D | 5.0 | 5.0 | 5.0 | 5.0 | 5.0 | 5.0 |
| F | 0.4 | 0.4 | 0.4 | 0.4 | 0.4 | 0.4 |
| E1 | 0.4 | 0.4 | 0.4 | 0.4 | 0.4 | 0.4 |
| E2 | 0.1 | 0.1 | 0.1 | 0.1 | 0.1 | 0.4 |
| Trimer content of phosphazene (mol %) | 40.5 | 64.5 | 71.6 | 82.2 | 90.8 | 100.0 |
| Properties | | | | | | |
| Vicat B 120 | 124 | 124 | 124 | 122 | 121 | 122 |
| UL 94 V at 1.5 mm (7 d/70° C.) thickness/total | V-0/10 s | V-0/10 s | V-0/10 s | V-0/10 s | V-0/12 s | V-0/11 s |
| afterburn time | | | | | | |
| MVR 240° C./5 kg [cm³/10 min] | 7.70 | 7.50 | 8.50 | 7.80 | 9.20 | 8.80 |
| MVR 240° C./5 kg after hydrolysis | 13.50 | 12.30 | 12.50 | 12.70 | 15.10 | 14.30 |
| (7 d/95° C./99% RH) [cm³/10 min] | | | | | | |
| delta MVR after hydrolysis [%] | 75.3 | 64.0 | 47.0 | 62.8 | 64.1 | 62.5 |
| E modulus [N/mm²] | 2318 | 2334 | 2351 | 2382 | 2376 | 2326 |
| Tear strength [N/mm²] | 53.4 | 55.9 | 54.3 | 56.9 | 55.7 | 57 |
| IZOD notched impact strength [kJ/m²] | 62.6 | 63.3 | 64.1 | 63.9 | 64.4 | 64.5 |
| Weld strength [kJ/m²] | 11.5 | 11.9 | 11.9 | 12.2 | 12.6 | 12.8 |
| ESC test (rapeseed oil), 2.4% peripheral fibre | 390 | 390 | 420 | 420 | 300 | 280 |
| stretching, time to fracture [min] | | | | | | |

1. Composition comprising:
A) 60-95 parts by weight of aromatic polycarbonate and/or aromatic polyestercarbonate,
B) 1.0-15.0 parts by weight of rubber-modified graft polymer,
C) 1.0-14.5 parts by weight of at least one cyclic phosphazene of formula (X): 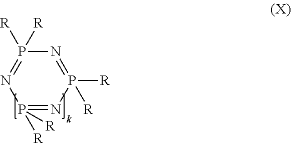
where
k is 1 or an integer from 1 to 10, optionally a number from 1 to 8 and optionally 1 to 5,
the trimer content (k=1) being from 60 to 98 mol %, based on component C,
and where
R are in each case identical or different and are an amine radical, C₁- to C₈-alkyl in each case optionally halogenated, optionally with fluorine, optionally methyl, ethyl, propyl or butyl, C₁- to C₈-alkoxy, optionally methoxy, ethoxy, propoxy or butoxy, C₅- to C₆-cycloalkyl in each case optionally substituted by alkyl, optionally C₁-C₄-alkyl, and/or halogen, optionally chlorine and/or bromine, C₆- to C₂₀-aryloxy in each case optionally substituted by alkyl, preferably C₁-C₄-alkyl, and/or halogen, optionally chlorine or bromine, and/or hydroxyl, optionally phenoxy or naphthyloxy, C₇- to C₁₂-aralkyl in each case optionally substituted by alkyl, optionally C₁-C₄-alkyl, and/or halogen, optionally chlorine and/or bromine, optionally phenyl-C₁-C₄-alkyl, or a halogen radical, optionally chlorine, or an OH radical,
D) 0-15.0 parts by weight of rubber-free vinyl (co)polymer or polyalkylene terephthalate,
E) 0-15.0 parts by weight of one or more additives and
F) 0.05 to 5.00 parts by weight, optionally 0.1 to 2.0 parts by weight and optionally 0.1 to 1.0 part by weight of antidripping agent,
all the parts by weight optionally being scaled so that the sum of the parts by weight of all the components A+B+C+D+E+F in the composition is 100.

2. Composition according to claim 1, wherein the trimer content (k=1) is from 60 to 98 mol %, optionally from 65 to 95 mol %, optionally from 70 to 95 mol % and optionally from 70 to 90 mol %, based on component C.

3. Composition according to claim 1, wherein the proportion of component C is 4.5-8.0 parts by weight.

4. Composition according to claim 1, wherein
component C is selected from the group consisting of propoxyphosphazenes, phenoxyphosphazenes, methylphenoxyphosphazenes, aminophosphazenes and fluoroalkylphosphazenes.

5. Composition according to claim 1, wherein R=phenoxy.

6. Composition according to claim 1, wherein the trimer content (k=1) is 70-85 mol %, based on component C.

7. Composition according to claim 1, wherein the trimer content (k=1) is from 65 to 85 mol %, the tetramer content (k=2) is from 10 to 20 mol %, the higher oligomeric phosphazene content (k=3, 4, 5, 6 and 7) is from 5 to 15 mol % and the phosphazene oligomer content where k≧8 is from 0 to 1 mol %, based in each case on component C.

8. Composition according to claim 1, wherein component D is present in a proportion of 2.0-12.5 parts by weight.

9. Composition according to claim 1, wherein the thermoplastic aromatic polycarbonates have a weight-average molecular weight of 22,000 to 30,000 g/mol.

10. Composition according to claim 1 which comprise as component E at least one additive selected from the group consisting of flameproofing synergistic agents, antidripping agents, lubricants and demoulding agents, nucleating agents, stabilizers, antistatic agents, dyestuffs, pigments, fillers and reinforcing agents.

11. Composition according to claim 1, wherein the graft base of component B is selected from the group consisting of diene rubbers, EP(D)M rubbers, and acrylate, polyurethane, chloroprene and ethylene/vinyl acetate rubbers.

12. A cyclic phosphazene of formula (X): 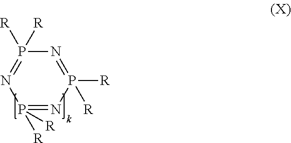
Capable of being used for preparation of flameproofed polymer composition with increased hydrolysis stability and chemical resistance,
where
k is 1 or an integer from 1 to 10, preferably a number from 1 to 8 and optionally 1 to 5,
the trimer content (k=1) being from 60 to 98 mol %, based on component C,
and where
R are in each case identical or different and are an amine radical, C₁- to C₈-alkyl in each case optionally halogenated, optionally with fluorine, optionally methyl, ethyl, propyl or butyl, C₁- to C₈-alkoxy, optionally methoxy, ethoxy, propoxy or butoxy, C₅- to C₆-cycloalkyl in each case optionally substituted by alkyl, optionally C₁-C₄-alkyl, and/or halogen, optionally chlorine and/or bromine, C₆- to C₂₀-aryloxy in each case optionally substituted by alkyl, optionally C₁-C₄-alkyl, and/or halogen, optionally chlorine or bromine, and/or hydroxyl, optionally phenoxy or naphthyloxy, C₇- to C₁₂-aralkyl in each case optionally substituted by alkyl, preferably C₁-C₄-alkyl, and/or halogen, optionally chlorine and/or bromine, optionally phenyl-C₁-C₄-alkyl, or a halogen radical, optionally chlorine, or an OH radical.

13. A composition according to claim 1 capable of being used for production of an injection-moulded and/or thermoformed article.

14. Moulded article obtainable from a composition according to claim 1.
